(19) United States
(12) Patent Application Publication
(10) Pub. No.: US 2013/0014343 A1
(43) Pub. Date: Jan. 17, 2013

(54) SLIDE ASSIST DEVICE

(71) Applicants: Akihiko Tanno, Fujisawa-shi (JP); Kazuyuki Tomioka, Ashigarakami-gun (JP)

(72) Inventors: Akihiko Tanno, Fujisawa-shi (JP); Kazuyuki Tomioka, Ashigarakami-gun (JP)

(73) Assignee: NIFCO INC., Yokohama-shi, Kanagawa (JP)

(21) Appl. No.: 13/583,443

(22) PCT Filed: Mar. 17, 2011
(86) PCT No.: PCT/JP2011/056351

§ 371 Date: Sep. 20, 2012

(30) Foreign Application Priority Data
Mar. 17, 2010 (JP) 2010-060240

(51) Int. Cl. E05F 1/16; E05F 3/04; E05F 3/02

(52) U.S. Cl. 16/49

(57) ABSTRACT

A slide assist device includes a draw-in unit including a case attached to one of a main body or a mobile body, a slider slideably placed on the case, a latch supported in the slider and switchable between a standby position locked in a corresponding portion of the case and a draw-in position releasing the locking, and an urging device; and an actuating member attached to the other of the main body or the mobile body, switching the latch from the standby position to the draw-in position, or from the draw-in position to the standby position. By switching the latch from the standby position to the draw-in position, an urging force moves the mobile body from a first position to a second position through the actuating member. At least one of either the slider or the case is disposed in a mutually opposed portion, and protrudes toward a mating side.

### FIELD OF TECHNOLOGY

The present invention relates to a slide assist device which assists an operation switching a mobile body such as a sliding door, a door, and the like from the first position on a main body side to a second position, or switching the mobile body from the second position to the first position by using an urging force.

### BACKGROUND ART

FIGS. 11(a) and 11(b) show a slide assist device of the following Patent Document 1. Characteristics of the device are that a main body frame slideably disposes the sliding door or the door; a projecting body 9, which is an actuating member, is provided in the sliding door or the door; and the sliding door or the door is drawn in through the projecting body 9 by a draw-in unit which is a main portion of the slide assist device provided in the main body frame. The draw-in unit comprises a case 1 attached to the main body frame; sliders 2A and 2B slideably placed on the case 1; a latch 5 rotatably supported relative to each slider 2A and 2B through a shaft 8; and an urging device 3. The projecting body 9 is provided to protrude on an upper end surface of the sliding door or the door.

There, the case 1 is formed slenderly and also thinly by a relationship in which the case 1 is disposed along a guiding groove of the main body frame. Each slider 2A and 2B includes a convex portion 22 provided on upper and lower surfaces. Each convex portion 22 fits into guide grooves 12b and 16b provided on the upper and lower surfaces of the case 1, and each convex portion 22 is slid while being guided by the guide grooves 12b and 16b. Also, each latch 5 includes a protrusion 52 provided on the upper and lower surfaces. Each protrusion 52 fits into guide grooves 14 and 19 provided on the upper and lower surfaces of the case 1, and each protrusion 52 is slid while being guided by the guide grooves 14 and 19. Each guide groove and 19 comprises straight grooves 14a and 19a parallel to the guide grooves 12b and 16b, and locking grooves 14b and 19b with an approximately L shape provided on both sides of the straight grooves 14a and 19a.

In the above-mentioned slide assist device, the latch 5 on both sides in FIG. 11(a) and the latch 5 on the right side of FIG. 11(b) are in a standby position. In the standby position, the upper and lower protrusions 52 are locked in the corresponding locking grooves 14b and 19b, and positions of the latches 5 are controlled against an urging force accumulated in the urging device 3 together with the slider 2A. Then, from a state in FIG. 11(a), when the sliding door or the door which is in an open position on the left side (not shown in the figure) is operated to slide in a closing direction from the open position, the projecting body 9 hits against an inner surface of a hook portion 50 of the corresponding latch 5 of the draw-in unit, and the latch 5 is rotated by stress thereof, and is switched to a draw-in position as shown on the left side of FIG. 11(b) from the standby position. In the draw-in position, in a state wherein the latch 5 has constrained the projecting body 9 inside the hook portion, the upper and lower protrusions 52 enter into the straight grooves 14a and 19a from the locking grooves 14b and 19b so as to release the locking. Consequently, the latch 5 and the slider 2A are slid by the urging force accumulated in the urging device 3, and automatically switch the sliding door or the door to a closed position through the projecting body 9. Also, from the closed position, by an opening operation of the sliding door or the door, when the projecting body 9 is slid to the left side of the figure together with the latch 5, accompanied by that, the urging force is accumulated in the urging device 3. Moreover, when the sliding door or the door is moved in an open direction, the latch 5 is switched to the standby position again.

### PRIOR ART DOCUMENT

### Patent Document

Patent Document 1: Japanese Unexamined Patent Publication No. 2008-144567

### SUMMARY OF THE INVENTION

### Problems to be Solved by the Invention

In the aforementioned slide assist device, for example, when the sliding door or the door is operated to be closed, the sliding door or the door is automatically switched up to the closed position by the urging force from the middle of the closing operation so as to improve usability of the sliding door or the door, and to be capable of solving an occurrence of an incomplete closed state of the sliding door or the door. Also, the aforementioned draw-in unit can be structured by a pair of latches and sliders, and an urging device as shown in FIGS. 1(a) and 1(b) wherein the present invention is applied in place of an embodiment which is applied to right-and-left sliding doors or the door. Furthermore, the aforementioned draw-in unit can be structured by the single latch and slider, and the urging device as shown in FIG. 10.

As for the slide assist device, however, for example, in order to maintain a flat downsizing and a stable sliding property, and to lengthen a sliding distance of the mobile body by the urging force, as shown in a slide assist mechanism (for example, see Japanese Unexamined Patent Publication No. 2011-006872) in which the present applicants have developed previously, on the assumption that the slider is slid in a longitudinal direction inside the case as much as possible, especially, a stable switching actuation from the draw-in position to the standby position of the latch is important, i.e., it is important that the protrusion on a latch side enters into the locking groove from the straight groove on a guide groove side so as to lock the latch, and that the locking cannot be unlocked abruptly by a vibration, an impact, and the like.

### Means for Solving the Problems

In order to achieve the aforementioned object, the present invention provides a slide assist device having characteristics of either of the following (1) to (4).

(1) The slide assist device comprises a draw-in unit including a case attached to one of a main body or a mobile body; a slider slideably placed on the case; a latch supported in the slider, and switched between a standby position locked in a corresponding portion of the case and a draw-in position releasing the aforementioned locking, and an urging device. The slide assist device also comprises an actuating member attached to the other of the main body or the mobile body, and switching the latch from the standby position to the draw-in position, or switching the latch from the draw-in position to the standby position. By switching the latch from the standby position to the draw-in position, an urging force accumulated in the urging device moves the mobile body from the first position on a main body side to a second position through the actuating member. In the slide assist device, at least one of the slider and the case is disposed in a mutual opposed portion, and abutably protrudes toward a mating side.

(2) The slide assist device comprises a draw-in unit including a case attached to one of the main body or the mobile body; right-and-left sliders slideably placed on the case; a pair of latches supported in the sliders, and switched between the standby position locked in the corresponding portion of the case and the draw-in position releasing the aforementioned locking, and an urging device urging in a direction of moving both the sliders or both the latches close to each other; and actuating members attached to the other of the main body or the mobile body, and switching the latches from the standby position to the draw-in position, or switching the latches from the draw-in position to the standby position. When the latches are switched from the standby position to the draw-in position, the urging force accumulated in the urging device moves the mobile body from the first position on the main body side to the second position through the actuating members. In the slide assist device, at least one of the sliders and the case is disposed in the mutual opposed portion, and abutably protrudes toward the mating side.

(3) In the slide assist device of the aforementioned (1) or (2), the urging device is a coil spring, and in the coil spring, there is provided a buffering portion which buffers a vibration and an impact applied to the slider.

(4) In the slide assist device of the aforementioned (3), the coil spring is fixed in the slider or the case by engaging an engaged portion formed in one portion thereof with an engaging portion provided in the slider or the case. The buffering portion is provided on an end portion side of the coil spring than the engaged portion, and a winding pitch of the buffering portion in the coil spring is larger than a winding pitch of the engaged portion.

As for the above-mentioned mobile body, there include a drawer and the like other than a sliding door or a door. As for the main body, there also include a frame for the sliding door or the door, a storage portion for the drawer, and the like. The first position shows a completely closed position or a completely open position of the mobile body, and also includes a closed position wherein the mobile body has been completely pushed into the storage portion, or an open position wherein the mobile body has been completely pulled out. The second position shows a completely open position or a completely closed position of the mobile body, and also includes an open position wherein the mobile body has been completely pulled out of the storage portion, or a closed position wherein the mobile body has been completely pushed in. Incidentally, the slide assist device preferably includes piston-type braking means putting a brake on a speed which is moved by the urging force of the mobile body in terms of an actuation property. In that case, structural members (a cylinder and a piston rod) of the braking means thereof have to be fixed in the slider or the case. However, a fixation structure of especially, the piston rod, which becomes a small diameter, becomes a problem. As for a countermeasure thereof, as shown in an embodiment, from a state wherein the piston rod is temporarily attached once, the piston rod is firmly attached relative to the slider or the case by an engaging operation of an attachment member.

### Effect of the Invention

In the slide assist device having either characteristic of the aforementioned (1) or (2), for example, in order to lengthen a sliding distance of the mobile body by the urging force, when the sliding distance of the slider inside the case is extended as much as possible, the slide assist device has a structure that an end portion of the slider is disposed to abut against or to come close to a case inner end surface which is in a longitudinal direction inside the case in the standby position of the latch. There, in the slide assist device of the present invention, the buffering portion abutably protruding toward the mating side is provided at least one of the slider and the case, so that especially, when the latch is switched from the draw-in position to the standby position, or in the standby position, the buffering portion absorbs the vibration or the impact so as to prevent a mis-actuation of the latch supported in the slider, and to improve the actuation property.

Also, in the slide assist device having the characteristic of (3), in the buffering portion, as for the urging device, the coil spring is used. Also, in the coil spring, the buffering portion which buffers the vibration and the impact applied to the slider is integrally provided so as to be capable of reducing the number of parts and attachment hours.

Also, in the slide assist device having the characteristic of (4), since the winding pitch of the buffering portion is larger than the winding pitch of the other portion of the coil spring which is the urging device, the slide assist device excels in performance of buffering the vibration and the impact applied to the slider.

### BRIEF DESCRIPTION OF THE DRAWINGS

FIG. 1(a) is a plan view showing a state wherein a cover 15 is removed from a case 1 forming a draw-in unit 6 which is a main portion of a slide assist device according to an embodiment of the present invention.

FIG. 1(b) is a drawing showing an inner surface side of the cover 15.

FIG. 2(a) is a cross-sectional view in a cross-section taken along a line A to A in FIG. 1(a).

FIG. 2(b) is a cross-sectional view in a cross-section taken along a line B to B in FIG. 1(a).

FIG. 2(c) is a cross-sectional view in a cross-section taken along a line C to C in FIG. 1(a).

FIG. 3(a) is a schematic view wherein an inside of a frame shown by assigning the reference alphabet “D” in FIG. 1(a) is enlarged, and shows a standby position of a latch 4.

FIG. 3(b) is a schematic view wherein the inside of the frame shown by assigning the reference alphabet “D” in FIG. 1(a) is enlarged, and shows a draw-in position of the latch 4.

FIG. 4 is a plan view showing the case 1 without the cover 15 together with an urging device and braking means.

FIG. 5(a) is a plan view of a slider 2A.

FIG. 5(b) is a bottom view of the slider 2A.

FIG. 5(c) is a drawing showing a structure inside a frame shown by assigning the reference alphabet “E” in FIG. 5(a).

FIG. 5(d) is a plan view of a connecting portion 21 in a state wherein an attachment member 29 is removed.

FIG. 6(a) is a plan view of a slider 2B.

FIG. 6(b) is a bottom view of the slider 2B.

FIG. 7(a) is a plan view of the latch 4 in the draw-in unit 6.

FIG. 7(b) is a bottom view of the latch 4 in the draw-in unit 6.

FIG. 7(c) is a front view of the latch 4 in the draw-in unit 6.

FIG. 8(a) is a schematic view showing the latch 4 and a surrounding portion thereof when the latch 4 is in the standby position.

FIG. 8(b) is a schematic view showing the latch 4 and the surrounding portion thereof when the latch 4 is in the standby position.

FIG. 8(c) is a schematic view showing the latch 4 and the surrounding portion thereof when the latch 4 is switched from the standby position to the draw-in position.

FIG. 8(d) is a pattern diagram showing a process wherein an urging force is being accumulated in a coil spring 3.

FIG. 9(a) is a drawing showing a state wherein the slide assist device according to the present embodiment is applied to a main body 7 and a sliding portion of a door A (a mobile body).

FIG. 9(b) is a drawing showing a state wherein the slide assist device according to the present embodiment is applied to the main body 7 and the sliding portion of the door A (the mobile body).

FIG. 9(c) is a perspective view showing a structural example of a projecting body 8 (an actuating member).

FIG. 10 is a structural view showing a modified example of the draw-in unit 6 corresponding to FIG. 1(a).

FIG. 11(a) is a schematic structural view of a draw-in unit in a slide assist device of Patent Document 1.

FIG. 11(b) is a substantial operational view of the draw-in unit in the slide assist device of the Patent Document 1.

### BEST MODES OF CARRYING OUT THE INVENTION

Hereinafter, a slide assist device according to an embodiment of the present invention will be explained with reference to the drawings in the order of device characteristics, a draw-in unit, an actuating member, an assembly, an actuation, and a modified example.

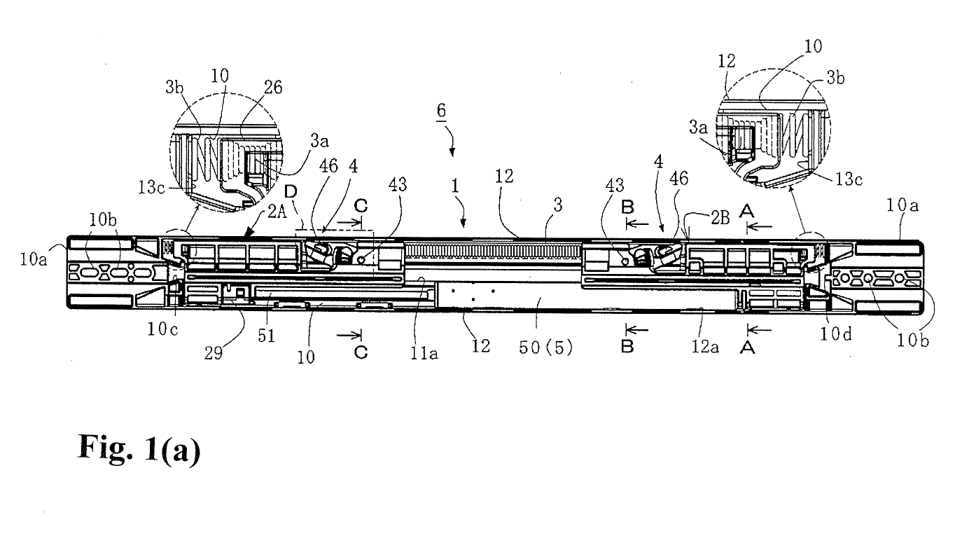

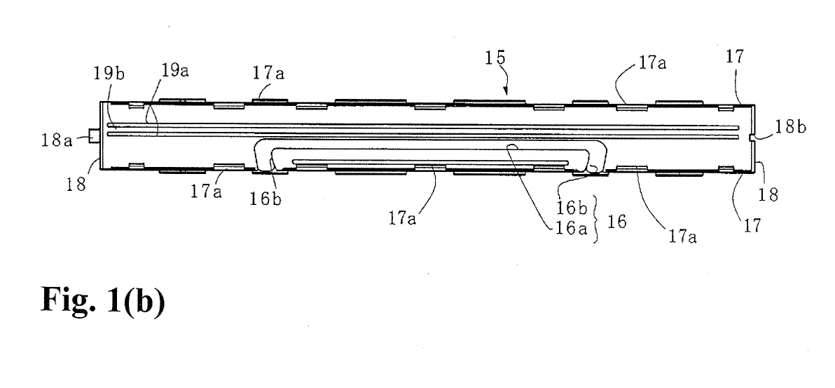

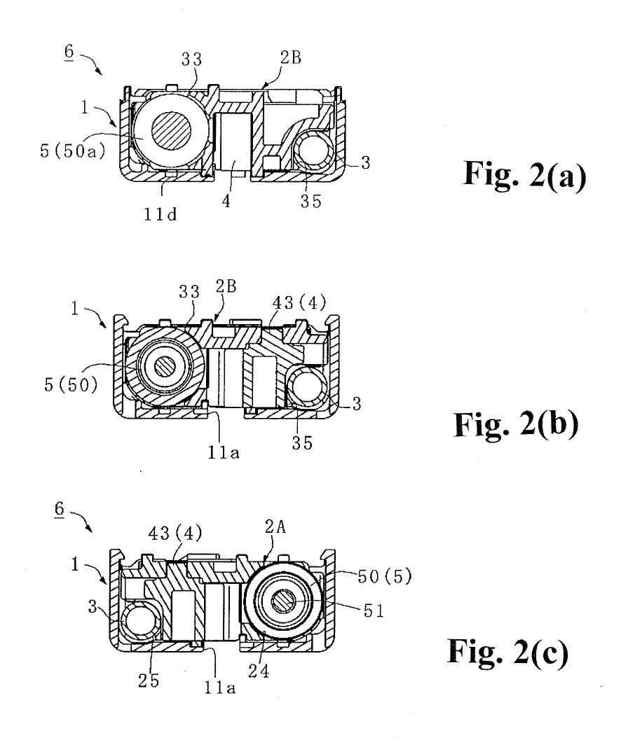

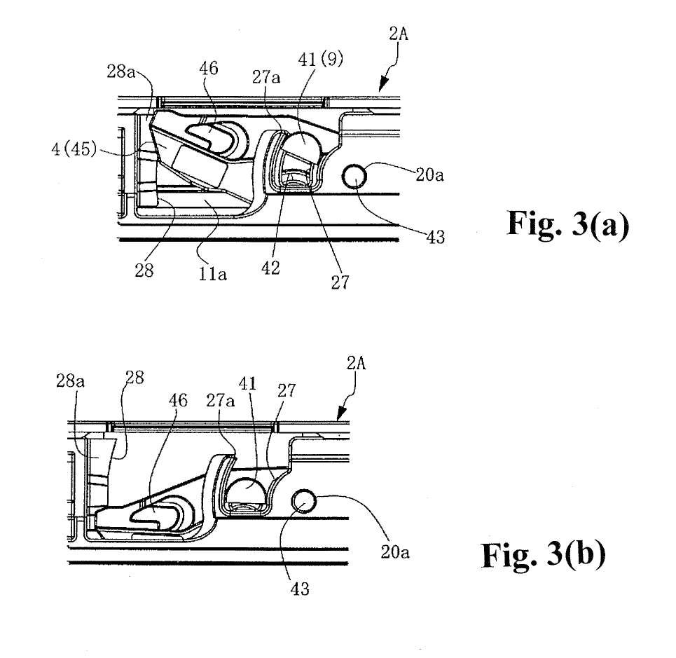

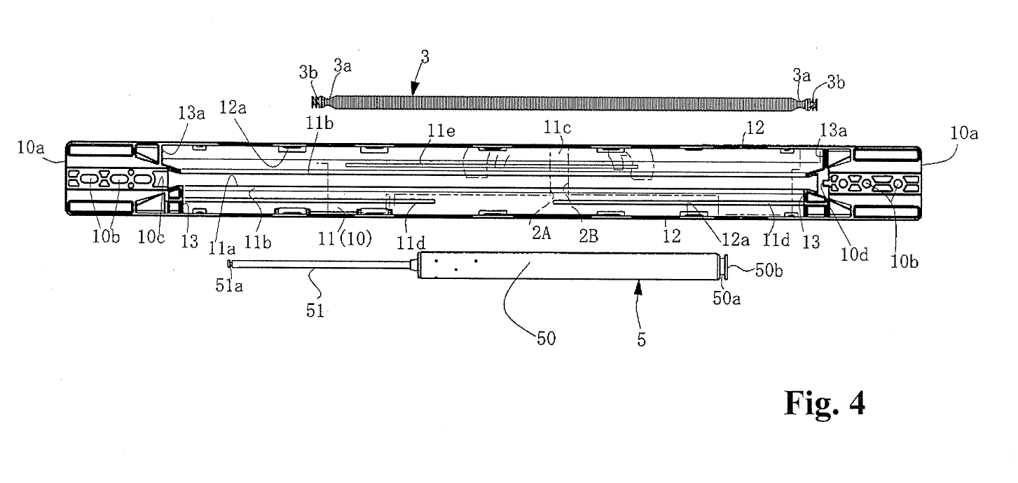

FIG. 1(a) is a plan view showing a state wherein a cover 15 is removed from a case 1 structuring a draw-in unit 6 which is a main portion of the slide assist device according to the embodiment of the present invention. Also, FIG. 1(b) is a drawing showing an inner surface side of the cover 15. Also, FIG. 2(a) is a cross-sectional view in a cross-section taken along a line A to A in FIG. 1(a). Also, FIG. 2(b) is a cross-sectional view in a cross-section taken along a line B to B in FIG. 1(a). Also, FIG. 2(c) is a cross-sectional view in a cross-section taken along a line C to C in FIG. 1(a). Also, FIG. 3(a) is a schematic view wherein an inside of a frame shown by assigning the reference alphabet “D” in FIG. 1(a) is enlarged, and shows a standby position of a latch 4. Also, FIG. 3(b) is a schematic view wherein the inside of the frame shown by assigning the reference alphabet “D” in FIG. 1(a) is enlarged, and shows a draw-in position of the latch 4. Also, FIG. 4 is a plan view showing the case 1 without the cover 15 together with an urging device and braking means.

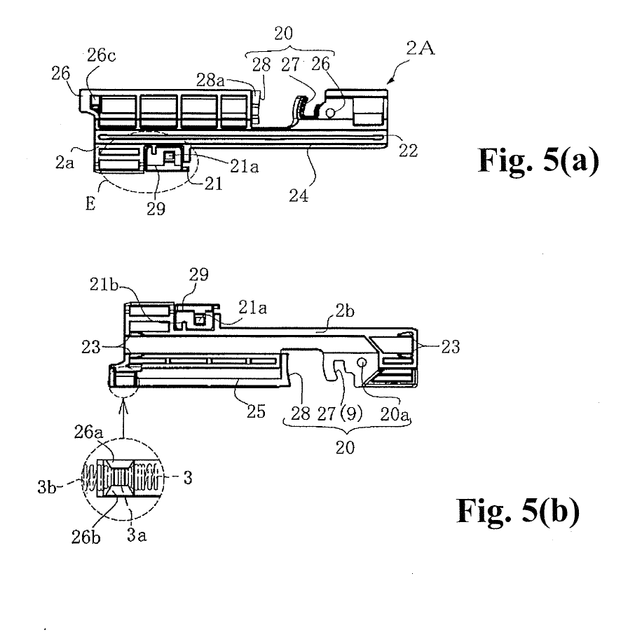

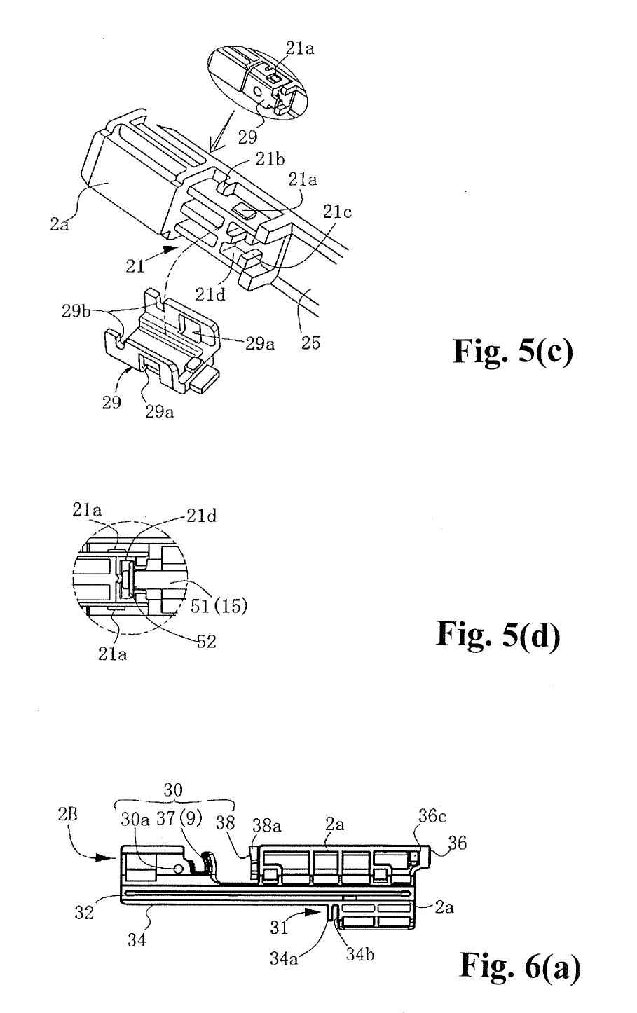

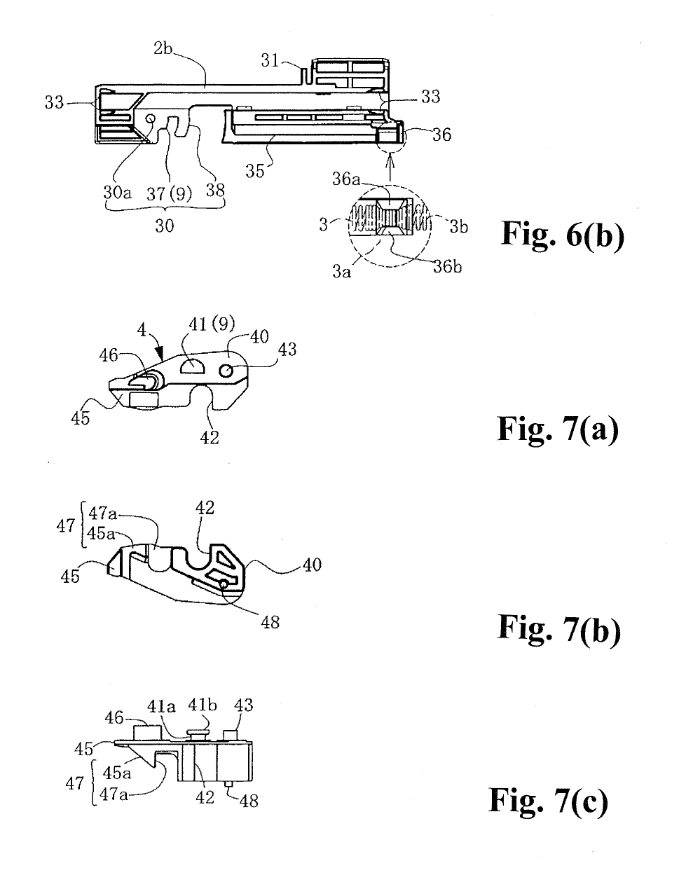

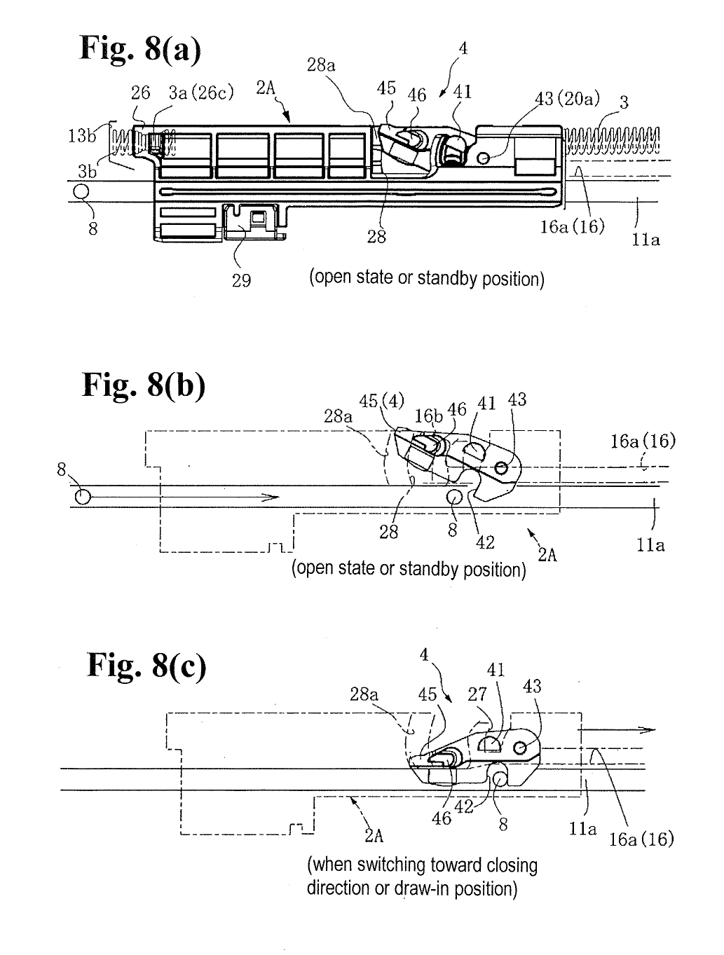

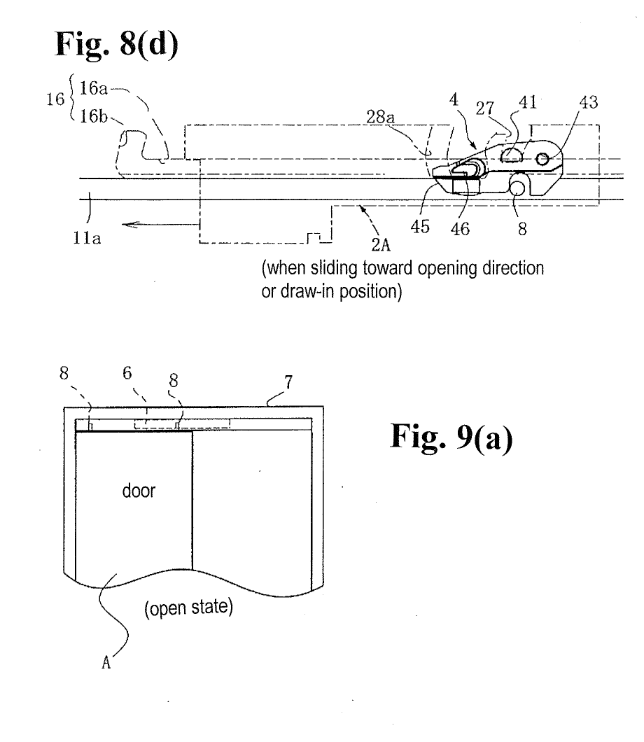

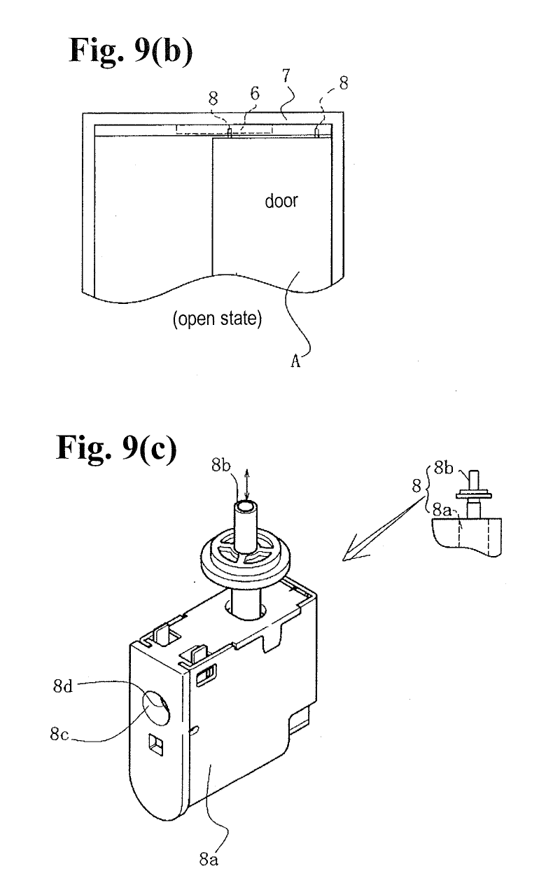

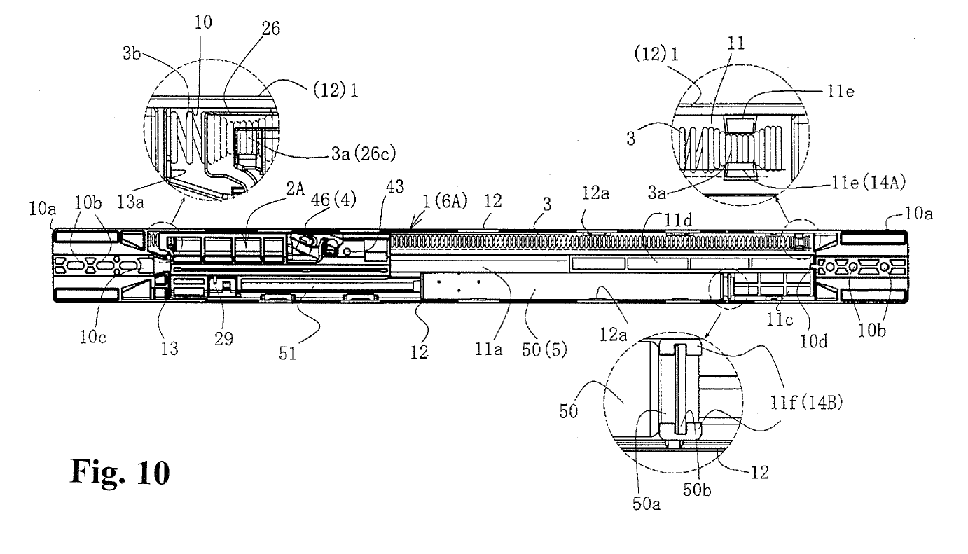

Also, FIG. 5(a) is a plan view of a slider 2A. Also, FIG. 5(b) is a bottom view of the slider 2A. Also, FIG. 5(c) is a drawing showing a structure inside a frame shown by assigning the reference alphabet “E” in FIG. 5(a). Also, FIG. 5(d) is a plan view of a connecting portion 21 in a state wherein an attachment member 29 is removed. Also, FIG. 6(a) is a plan view of a slider 2B. Also, FIG. 6(b) is a bottom view of the slider 2B. Also, FIG. 7(a) is a plan view of the latch 4 in the draw-in unit 6. Also, FIG. 7(b) is a bottom view of the latch 4 in the draw-in unit 6. Also, FIG. 7(c) is a front view of the latch 4 in the draw-in unit 6. Also, FIG. 8(a) is a schematic view showing the latch 4 and a surrounding portion thereof when the latch 4 is in the standby position. Also, FIG. 8(b) is a schematic view showing the latch 4 and the surrounding portion thereof when the latch 4 is in the standby position. Also, FIG. 8(c) is a schematic view showing the latch 4 and the surrounding portion thereof when the latch 4 is switched from the standby position to the draw-in position. Also, FIG. 8(d) is a pattern diagram showing a process wherein an urging force is being accumulated in a coil spring 3. Also, FIG. 9(a) is a drawing showing a condition wherein the slide assist device according to the present embodiment is applied to a main body 7 and a sliding portion of a door A (a mobile body). Also, FIG. 9(b) is a drawing showing a condition wherein the slide assist device according to the present embodiment is applied to the main body 7 and the sliding portion of the door A (the mobile body). Also, FIG. 9(c) is a perspective view showing a structural example of a projecting body 8 (an actuating member). Also, FIG. 10 is a structural view showing a modified example of the draw-in unit 6 corresponding to FIG. 1(a).

(Device Characteristics)

The slide assist device according to the present embodiment comprises the draw-in unit 6 attached to one of the main body 7 or the mobile body (hereinafter, explained in an example of the door A) such as a sliding door, the door A, and the like; and the projecting body 8 attached to the other of the main body 7 or the door A. Incidentally, the door A is one example of the mobile body which becomes an attachment object of the slide assist device, and the projecting body 8 is one example of the actuating member in the present invention. Also, in the present example, a case, where the draw-in unit 6 is attached to the main body 7, and where the projecting body 8 is attached to the door A, is shown; however, the draw-in unit 6 can be attached to the door A, and also the projecting body 8 can be attached to the main body 7. Also, a structure of the draw-in unit 6 and the projecting body 8 is broadly divided into the following three types by an attached mobile body or a draw-in actuation setup.

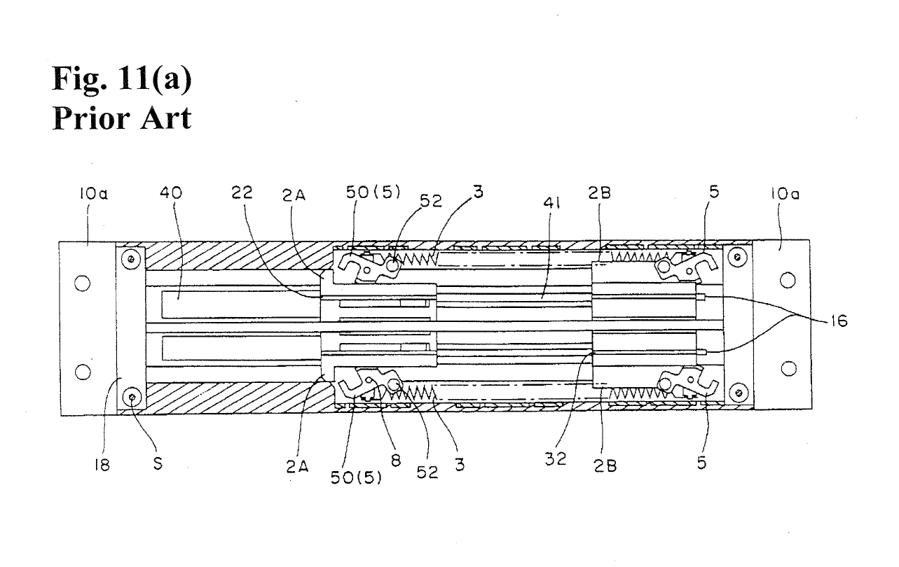

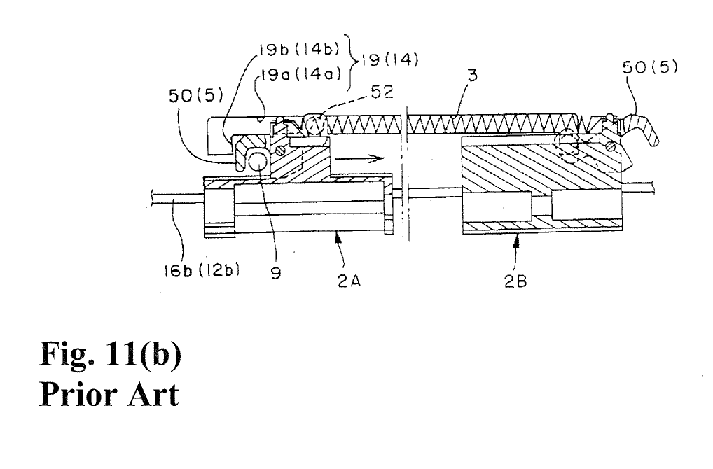

The first structure is a case where the draw-in unit 6 and two projecting bodies 8 as a pair are used. The draw-in unit 6 disposes a pair of the sliders 2A and 2B which is slid in a direction of moving toward and away from each other relative to the case 1; the coil spring 3 urging in a direction of moving both the sliders 2A and 2B close to each other; braking means 5 putting a brake on a sliding speed of the sliders 2A and 2B; and a pair of the latches 4 rotatably supported respectively in each slider 2A and 2B, and releasably locked in a corresponding portion inside the case 1 so as to be capable of holding both the sliders 2A and 2B in a separated state. Compared to FIGS. 11(a) and 11(b), the draw-in unit 6 includes control means 9 which maintains a horizontal rotation movement of the latches 4 relative to the sliders 2A and 2B when the latches 4 are switched between the standby position which locks in the corresponding portions (locking grooves 16b of a guide portion 16) of the case 1 through the projecting bodies 8 and the draw-in position which releases the aforementioned locking; and the braking means 5 which puts the brake on the sliding speed of the sliders 2A and 2B. Incidentally, the coil spring 3 is one example of the urging device in the present invention.

A second structure is a case wherein as the mobile body, for example, the double-door-type door (the sliding door) A and a door B respectively slide relative to a corresponding opening portion of the Main body 7. Structural members of the draw-in unit 6 corresponding to one door A and the draw-in unit 6 corresponding to the other door B are embedded in the common case as shown in FIGS. 11(a) and 11(b). Namely, in the draw-in unit 6, there is a unit of the right-and-left sliders 2A and 2B which are slid in the direction of moving toward and away from each other; the coil spring 3 urging in the direction of moving both the sliders 2A and 2B close to each other; and a pair of the latches 4 pivotally supported respectively in each slider 2A and 2B, and also releasably locked in a case 1 side so as to be capable of holding both the sliders 2A and 2B in the separated state. The draw-in unit 6 has the structure wherein two pairs of the above are disposed relative to the same case 1. Since an explanation of the above can be easily inferred from the embodiment, the explanation is omitted.

A third structure is a case where the mobile body is drawn in only in one direction. As shown in FIG. 10 as the example, the draw-in unit 6 is the most simplified structure in which one of the sliders 2A and 2B in FIG. 1(a) is omitted, one end of the coil spring 3 is locked in the slider, and also the other end is locked in the case 1 side, and as necessary, one end of the braking means 5 is locked in the slider 2A, and also the other end is locked in the case 1 side. Then, in the first to third structures, as a common essential part, in at least one of the sliders 2A and 2B and the case 1, there include elongation portions 3b disposed in a mutually opposing portion, and abuttably protruding toward a mating side. Incidentally, the elongation portions 3b are one example of a buffering portion in the present invention, and as mentioned later, the elongation portions 3b buffer a vibration and an impact applied to the sliders 2A and 2B.

(Draw-In Unit)

The case 1 of the draw-in unit 6 is a slender part with an approximately cuboid shape, and includes an internal space 10 divided by a lower surface 11, both side surfaces 12, and right-and-left end walls 13a. On an upper side of the internal space 10, there is provided an opening. Also, the above-mentioned opening is covered by the cover 15. Also, on the right and left of the internal space 10 in the case 1, there are provided attachment portions 10a for attaching the case 1 to the main body 7. Also, the end walls 13a divide the internal space 10 on an outer side than the end walls 13a in a longitudinal direction of the case 1, and on an inner surface of the end walls 13a, there abut the elongation portions 3b of the coil spring 3. On the lower surface 11, there are provided a guide hole 11a positioned in an intermediate portion in a width direction and extending to right and left; and slider guide portions lib wherein both edge portions of the guide hole 11a are formed one step lower than the guide hole 11a. A guide groove 11c is a shallow concave groove formed along an inner side of one side surface 12, and positions the sliders 2A and 2B, and one portion of the coil spring 3. Guide grooves 11d are concave grooves formed in order to facilitate a cylinder 50 structuring a piston damper (the braking means 5) to slide inside the case 1. A guide groove lie is a concave groove formed in order to fit into a convex portion 48 provided on a lower surface of the latch 4.

The cover 15 includes a slider guide groove 19b provided between a rib 19a and a rib 19a positioned in an approximately middle, and extending to right and left; and the approximately concave guide portion 16 for the latch 4 provided in the middle of the right and left. The guide portion 16 comprises a straight groove 16a extending to the right and left, and the locking grooves 16b with an approximately L shape provided on both sides of the straight groove 16a.

On both side surfaces 12 of the case 1 and both sides 17 on a cover side, there are provided hook-like locking portions 12a and concave engaging portions 17a mutually engaging when the cover 15 is disposed in the space portion 10 with a plurality of pairs. Also, in the attachment portions 10a of the case 1 and right-and-left end surfaces 18 of the cover 15, there are provided a concave locking portion 10c and a convex engaging portion 18a, and a convex locking portion 10d and a concave engaging portion 18b, which mutually engage when the cover 15 is disposed in the space portion 10. Then, in the example, the cover 15 is placed in the case 1 through engagements of the above-mentioned portions. The right-and-left attachment portions 10a have a cross-section of an inverted concave shape in the width direction, and the projecting body 8 can slide along the guide hole 11a from an inverted concave portion thereof.

The sliders 2A and 2B have a block shape made of resin, and are disposed in a space between the lower surface 11 of the case 1 and the cover 15. In the present example, as the braking means 5, since a piston-type damper is used, shapes of the slider 2A and the slider 2B differ. However, in such a case where a rotary damper is used as the braking means, the slider 2A and the slider 2B can also have the same shape.

The slider 2A and the slider 2B are common in the following respects. Connecting portions 21 and 31 for the braking means 5 form one portion of upper and lower surfaces 2a and 2b, and also include ribs 22 and 32 provided on the upper surface 2a and extending to right and left. Also, there include convex portions 23 and 33 provided in four corners of an approximately intermediate portion of the lower surface 2b. Also, there include guide portions 24 and 34 with an arc-like cross-section provided in parallel to one side, i.e., a connecting portion side, and guiding the braking means 5; and spring placement portions 25 and 35 provided along longitudinal direction on a lower surface side on the other side. Also, there include concave engaging portions 26 and 36 provided on one end side of each spring placement portion 25 and 35, and locking corresponding small diameter portions 3a of the coil spring 3. Also, there include latch placement portions 20 and 30 located on spring placement portions 25 and sides, and forming one portion on a lower side in an inverted concave shape. Also, there include escape grooves 28 and 38, and support grooves 27 and 37, provided on an upper wall portion dividing each latch placement portion 20 and 30; and pivotally supporting axis holes 20a and 30a. Each engaging portion 26 and 36 has an attaching clamping portion between both upper and lower projecting pieces 26a and 26b, or between both upper and lower projecting pieces 36a and 36b, and the small diameter portion 3a of the coil spring 3 can be fixed by a pressing force.

Here, as shown in FIGS. 7(a) and 7(b), the connecting portion 21 comprises claws 21a and positioning protrusions 21b provided in an upper portion and a lower portion thereof; a housing portion 21d including a window 21c opening in a horizontal direction; and the attachment member 29 placed in such a way as to cover the housing portion 21d. The attachment member 29 is structured by an approximately short-formed planar portion, and a lateral face portion vertically extending relative to the planar portion from both sides of the planar portion. Then, on the aforementioned lateral face portion of the attachment member 29, there are formed engaging holes 29a engaging with the claws 21a of the connecting portion 21; and concave portions 29b engaging with the protrusions 21b of the connecting portion 21. On the other hand, the connecting portion 31 includes an approximately U-shaped clamp portion 34a provided by maintaining a gap 34b between an inner end surface and the clamp portion 34a. Also, in the latch placement portions 20 and 30, the axis holes 20a and 30a are provided on end sides which are deviated from the center, and pass through up and down. As shown in FIG. 3(a), the support grooves 27 and 37 are located on the concentric circle as the axis holes 20a and 30a, are notched in an arc shape, and also include step differences 27a and 37a which become receiving faces provided along an upper edge. The escape grooves 28 and 38 are openings which are larger than the support grooves, and include a flange-like receiving portion 28a protruding along an inner side edge.

In the latches 4, the latch 4 used for the slider 2A and the latch 4 used for the slider 2B are bilaterally symmetric. FIGS. 7(a) to 7(c) show the latch 4 on a slider 2A side. To explain with reference to the same figures, the latch 4 is a resin molded body with a thickness size which can easily fit in the latch placement portions 20 and 30, and integrally forms a support portion 40 pivotally supporting to sliders 2A and 2B sides; an engaging portion 42 provided on one side of the support portion 40, and engaging with/disengaging from the projecting body 8, which is the actuating member, at a normal time; and assist engaging means 47 located on a latch lower surface side, and provided on an end portion 45 side rather than the engaging portion 42.

The support portion 40 includes a pivotally supporting axis portion 43 located on an upper surface side, and provided to protrude on an end portion side; a suspending support axis 41 provided to protrude near the center; and a protrusion 46 provided to protrude on an end side which is away from the axis portion 43. The latches 4 are rotatably assembled relative to the respective sliders 2A and 2B by the axis portion 43 fitted into the axis hole 20a or 30a on the sliders 2A and 2B sides. The support axis 41 structures the control means 9 together with the support groove 27 or 37, and includes a neck portion 41a slideably passed through the support groove 27 or 37, and a head portion 41b retaining the neck portion 41a thereof in a state being passed through the support groove 27 or 37. The protrusion 46 is formed higher than the axis portion 43 and the support axis 41, and in a state wherein the latch 4 is pivotally supported rotatably in each slider 2A and 2B, the latch 4 fits into the guide portion 16 on the cover side, slides along the straight groove 16a, and engages with the locking groove 16b so as to lock sliding of the latch 4 (and the sliders 2A and 2B).

The assist engaging means 47 engages with the projecting body 8 when the latch 4 has come to the draw-in position by a mis-actuation so as to be capable of switching the latch 4 from the draw-in position to the standby position. In the example, the assist engaging means 47 has a step-like shape whose end side is widely depressed on the latch lower surface side, and is structured by a slope-face guide portion 45a on an end side which guides the projecting body 8, and a concave portion 47a continuous with the slope-face guide portion 45a, and deepening one step. The slope-face guide portion 45a is a taper which lowers as the slope-face guide portion 45a goes to the end. In a used aspect, when the projecting body 8 abuts upward against the slope-face guide portion 45a, the projecting body 8 slides while reducing a protruding amount, and when the projecting body 8 enters into the concave portion 47a, the projecting body increases the protruding amount again so as to maintain an engagement with the concave portion 47.

In the present example, the coil spring 3 is a compression coil spring. In a slightly center-leaning position rather than end surfaces of both right and left ends in the coil spring 3, there are formed the small diameter portions 3a in which a diameter of a cross-section is narrowed down smaller than a center portion of the coil spring 3. On end surface sides rather than the small diameter portions 3a, there are provided the elongation portions 3b having an approximately equal diameter of the cross-section to that of the center portion of the coil spring 3. A winding pitch (an interval of neighboring coil wires) of the elongation portions 3b is larger than a winding pitch of the other portion such as the small diameter portions 3a and the like in the coil spring 3.

As for the braking means 5, the piston-type damper is used. The piston-type damper may be a publicly known piston-type damper (for example, see Japanese Unexamined Patent Publication No. 2006-29564 and the like), and may have a structure of including the cylinder 50, and a piston rod 51 gently protruding and entering with respect to the cylinder 50; of gently driving relative to the cylinder 50 wherein the piston rod 51 is fixed; or of gently driving relative to the piston rod 51 wherein the cylinder 50 is fixed. Also, the cylinder 50 includes a neck-like locking groove 50a on an outer circumference of a back end, and the piston rod 51 includes a neck-like locking groove 51a on an outer circumference of an end.

(Actuating Member)

The protruding body 8 is one example of the actuating member in the present invention, and has a structure freely protruding and entering with respect to the door A, which is one example of the mobile body, through the urging force, i.e., the structure of reducing the protruding amount against the urging force when the protruding body 8 receives a load. The present example is described in Japanese Unexamined Patent Publication No. 2011-001781 which is a prior application of the present applicants, and includes a case 8a attached to an upper end portion of the door A; a guide axis 8b protruding on the case 8a and guiding the door A along a guide rail on a stationary side; an adjustment member 8d disposed in a transverse hole 8c provided in the case 8a, and allowing a turning operation from an outside as an adjusting mechanism which adjusts a movement of the guide axis 8b in a width direction of the case 8a; an adjusting member which is not shown in the figures, and proceeds and recedes inside the case 8a by turning of the adjustment member 8d so as to adjust the movement of the guide axis 8b in the width direction; and the like. Naturally, the projecting body 8 is not limited to the above, and the projecting body 8 may have a guide axis structure which is disclosed in, for example, Japanese. Unexamined Patent Publication No. 2007-107301, or a structure similar to the above.

(Assembly)

For example, each above-mentioned member is assembled as follows. Namely, first, after each latch 4 is pivotally supported in the sliders 2A and 2B, both the sliders 2A and 2B are connected through the piston-type damper, which is the braking means 5, and the coil spring 3. Next, the above members are assembled to the case 1, and the cover 15 is attached to the case 1 so as to become the draw-in unit 6.

In the draw-in unit 6, each latch 4 is rotatably supported relative to the sliders 2A and 2B by fitting of the axis portion 43 and the axis hole 20a, or of the axis portion 43 and the axis hole 30a. In that support state, the support axis 41 is supported in a suspending state relative to the step difference 27a of the arc-like support groove 27, or to the step difference 37a of the support groove 37, and the protrusion 46 protrudes to an upper side of the sliders 2A and 2B by passing through the escape groove 28 or the escape groove 38, so that an end 45 is supported so as to be received in the flange-like receiving portion 28a or a receiving portion 38a provided on an inner side edge of the escape groove. After that, the slider 2A and the slider 2B are mutually connected through the piston-type damper which is the braking means 5. In that case, in the piston rod 51, in a state wherein the end of the piston rod 51 is inserted into the housing portion 21d from the window 21c relative to the connecting portion 21 of the slider 2A, as shown in FIG. 5(d), a retaining ring 52 engages with the locking groove 51a on the outer circumference of the rod end. After that, in the piston rod 51, the attachment member 29 is placed relative to the connecting portion 21 by engagements between the upper and lower claws 21a and the engaging holes 29a, and engagements between the protrusions 21b and the concave portions 29b so as to reliably fix a position. In the cylinder 50, only by matching the locking groove 50a on the aforementioned cylinder side to the gap 34b and by pressing, the cylinder 50 is engaged with and is connected to the clamp portion 34a relative to the connecting portion 31 of the slider 2B. Also, the coil spring 3 is locked and fixed relative to the engaging portions 26 and 36, wherein the small diameter portions 3a on both sides correspond, by a pressing operation relative to the sliders 2A and 2B. In that state, each elongation portion 3b protrudes only for a predetermined size more than a corresponding end of the sliders 2A and 2B.

Next, the sliders 2A and 2B with the above-mentioned latches 4 are disposed relative to the case 1 together with the braking means 5 and the coil spring 3. In the example, as guide means between the sliders 2A and 2B, and the case, the convex portions 23 or 33 on the lower surface of each slider 2A and 2B fit into the corresponding guide grooves 11b on the case 1 side; the rib 22 or 32 on the upper surface of each slider 2A and 2B fits into the corresponding guide groove 19b on the cover side; and the projecting pieces 26b and 36b on the lower surface of each slider 2A and 2B are slideably fitted into the guide groove 11c on the lower surface side of the case 1. Also, in the latch 4, the protrusion 46 is fitted into the guide portion 16 on the case 1 side from the escape groove 28 or 38 of the sliders 2A and 2B, and the latch 4 is switched between the draw-in position which is slid along the straight groove 16a accompanied by sliding of the sliders 2A and 2B, and the standby position which enters into the locking groove 16b from the straight groove 16a so as to be locked. Incidentally, in the latch 4, the convex portion 48 on the lower surface is consistently fitted into the guide groove lie on the lower surface of the case 1 so as to allow the latch 4 to stably follow even rapid sliding of the corresponding sliders 2A and 2B.

(Actuation)

FIGS. 8(a) to 8(d) show the actuation of the slide assist device and the draw-in unit 6 in the above-mentioned assembly state. Here, on the assumption that the slide assist device and the draw-in unit 6 are applied to the door A in FIGS. 9(a) and 9(b), the actuation of essential parts will be clarified.

(1) FIG. 8(a) shows a left side portion in the draw-in unit 6, i.e., the stand-by position (a state wherein the protrusion 46 on a latch side as engaged with the locking groove 16b of the guide portion 16 on the cover side) of the latch 4 on the slider 2A side together with the projecting body which is the actuating member. FIG. 8(b) shows the same aspect as that of FIG. 8(a) by showing only the slider 2A with imaginary lines so that a relationship of the members can be easily understood. In the standby position of the latch, the coil spring 3 is stretched, and the urging force has been accumulated. Also, the elongation portion 3b on the left side in the coil spring 3 abuts against the end wall 13a of the case 1. Consequently, in the structure, in the standby position of the latch 4, in the slider 2A pivotally supporting the latch 4 thereof, since the elongation portion 3b of the coil spring 3 abuts against the end wall 13a dividing the space portion 10 of the case 1, even if the slider 2A receives the vibration or the impact, the elongation portion 3b (the buffering portion) absorbs the vibration or the impact, so that the slider 2A cannot be easily affected by the vibration or the impact.

Namely, in the structure, due to a vibration or impact absorptive action of the elongation portion 3b (the buffering portion), the mis-actuation (the protrusion 46 moves from the locking groove 16b to the straight groove 16a) of the latch 4 which is supported in the slider 2A can be prevented so as to be capable of improving an actuation property. At the same time, the structure includes the aforementioned control means 9, and the latch 4 is supported in the support groove 27 or 37 on a slider side through the support axis 41 in the suspending state, and maintains a horizontal state so as to reliably prevent such mis-actuation.

(2) FIG. 8(c) shows a state wherein the latch has been switched to the draw-in position. In the positional switchover of the latch 4, when the latch 4 is in the standby position in FIG. 8(b), the door has been moved in a direction (a closing direction) wherein the door moves toward the right from the left in FIG. 8(b), and the projecting body 8 of the door hits against a corresponding portion of the engaging portion 42. Then, the latch 4 is rotated counterclockwise at a supporting point of the axis portion 43 by stress thereof, and the protrusion 46 is unlocked from the locking groove 16b so as to fit into the straight groove 16a, and the latch 4 is switched to the draw-in position wherein the projecting body 8 has engaged with the engaging portion 42. Then, the slider 2A is drawn into the slider 2B side by the urging force of the urging device 3 together with the latch 4 so as to switch the door to a closed position. In that case, in the embodiment, when the door is moved by the urging force of the urging device 3, the door receives braking of the aforementioned braking means 5 so as to be gently slid.

In the above-mentioned positional switchover, when the latch 4 is rotated counterclockwise at the supporting point of a pivotal support portion (the axis portion 43 and the axis hole 20a on the slider side), the support axis 41 is slid along the support groove 37 (in a state of being received by the step difference 37a) on the slider side, and the end portion 45 is received by the flange-like receiving portion 28a or 38a on an escape groove side, so that the control means 9 prevents the latch 4 from tilting relative to the slider 2A and reliably maintains the horizontal rotation movement. Thereby, in the structure, when the latch 4 is switched between the standby position and the draw-in position through the projecting body 8 which is the actuating member, a possibility, that due to a tilt and the like of the latch, the protrusion 46 might be deviated from the guide portion 16 so as to cause the mis-actuation, can be solved.

(3) FIG. 8(d) assumes a state wherein the door has been operated to slide in an open direction from the closed position. In that process, when the door is operated to move in a left direction from the right in FIG. 8(d), the slider 2A-is slid to a left side through the projecting body 8 engaged with the engaging portion 42 of the latch 4 which is in the drawn-in position. When the door is moved to the left further, and reaches the locking groove 16b on the left side as in the case of FIG. 8(b), while the latch 4 is rotating clockwise at the supporting point of the axis portion 43 by the stress caused when the projecting body 8 comes out of the engaging portion 42, the protrusion 46 engages with the locking groove 14b from the straight groove 14a so as to be switched to the standby position. Incidentally, in that process, the urging force is accumulated in the urging device 3. That state is maintained as long as the latch 4 is in the standby position.

In the above-mentioned positional switchover, in the structure, in such a case where the door is operated to slide rapidly and accompanied by that, the slider 2A is also slid at high speed, the elongation portion 3b abuts against the corresponding end wall 13a on a case side, and due to the impact absorptive action of the elongation portion 3b, the impact applied to the slider 2A is buffered so as to be capable of preventing the mis-actuation (the protrusion 46 moves from the locking groove 16b to the straight groove 16a) of the latch 4.

### MODIFIED EXAMPLE

FIG. 10 shows the aforementioned third structure (a structural example corresponding to the slide assist device including the characteristic described in the aforementioned (1)). In the explanation, the same symbols are assigned to the same parts as the aforementioned embodiment, and only changes are clarified. In the modified example, a shape on a right end side of the coil spring 3, and an attachment structure thereof, and an attachment part and an attachment structure of the cylinder 50 of the braking means 5, are modified.

Namely, the coil spring 3 protrudes the elongation portion 3b in a state wherein one small diameter portion 3a is locked in the engaging portion 26 of the slider 2A as mentioned above; however, the other small diameter portion 3a is locked and fixed in concave engaging portions 14A provided inside the case. As shown in FIG. 10, the engaging portions 14A have an attaching clamping portion between a pair of projecting pieces lie provided to stand on the lower surface 11 of the case 1, and the small diameter portion 3a of the coil spring 3 can be pressed and fixed in the attaching clamping portion. The engaging portions 14A close an upper opening between the projecting pieces lie by the cover 15 placed on the case 1, so that the small diameter portion 3a is pressed and fixed. Accordingly, the coil spring 3 cannot come out.

The cylinder 50 includes the neck-like locking groove 50a and a head portion 50b on an end side, and is locked and fixed in connecting portions 14B provided on the lower surface 11 of the case 1. As shown in FIG. 10, the connecting portions 14B have an attaching clamping portion between a pair of projecting pieces 11f provided to stand on the lower surface 11 of the case 1, and the locking groove 50a and the head portion 50b can be pressed and fixed in the attaching clamping portion. The connecting portions 14B close an upper opening between the projecting pieces 11f by the cover 15 placed on the case 1 as in the same manner as the engaging portions 14A so as to be capable of preventing the locking groove 50a and the head portion 50b from coming out.

As mentioned above, although the present invention is explained using the embodiment thereof, a technical scope of the present invention is not limited to a scope described in the aforementioned embodiment. It is obvious that a person skilled in the art can make various changes or improvements to the aforementioned embodiment. For example, as in the case of the present example, in place of the embodiment of providing the elongation portion 3b in the coil spring 3 so as to be the buffering portion, a dedicated elastic body may be attached to the end wall 13a, or to an opposed portion of the sliders 2A and 2B. Also, for example, in the structure of the draw-in unit 6 shown in FIG. 1(a) and FIG. 1(b), the following embodiment is also included, in which positions of one of the sliders 2A and 2B, and the latch 4 are controlled by a fixing member in the case 1 so that only the other of the sliders 2A and 2B, and the latch 4 can be activated. In that case, the aforementioned first structure and the aforementioned third structure can be selectively implemented.

The present application is based on Japanese Patent Application No. 2010-060240 filed on Mar. 17, 2010, and contents thereof are incorporated herein as references.

### EXPLANATION OF SYMBOLS

1 . . . a case (10 is an internal space, 11 is a lower surface, 12 is side surfaces, 13 and 13a are end portions, and 15 is a cover.)

2A . . . a slider (20 is a latch placement portion, 20a is an axis hole, 21 is a connecting portion, and 26 is an engaging portion.)

2B . . . a slider (30 is a latch placement portion, 30a is an axis hole, 36 is an engaging portion.)

3 . . . a coil spring (3a is a small diameter portion, and 3b is an elongation portion.)

4 . . . a latch (40 is a support portion, 41 is a support axis, is an engaging portion, 43 is an axis portion, 46 is a protrusion, and 47 is assist engaging means.)

5 . . . braking means (50 is a cylinder, and 51 is a piston rod.)

6 . . . a draw-in unit

7 . . . a main body

8 . . . a projecting body (an actuating member)

16 . . . a guide portion (16a is a straight groove, and 16b is a locking groove.)

A and B . . . doors (mobile bodies)

1. A slide assist device, comprising:
a draw-in unit including a case adapted to be attached to one of a main body or a mobile body, a slider slideably placed on the case, a latch supported in the slider and capable of switching between a standby position locked in a corresponding portion of the case and a draw-in position releasing the locking, and an urging device; and
an actuating member adapted to be attached to the other of the main body or the mobile body, switching the latch from the standby position to the draw-in position, or switching the latch from the draw-in position to the standby position,
wherein by switching the latch from the standby position to the draw-in position, an urging force accumulated in the urging device moves the mobile body from a first position on a main body side to a second position by means of the actuating member, and
at least one of the slider or the case is provided with a buffering portion disposed at a mutually opposed portion, and protruding toward a mating side.

2. A slide assist device, comprising:
a draw-in unit including a case adapted to be attached to one of a main body or a mobile body, right-and-left sliders slideably placed on the case, a pair of latches supported in the sliders and capable of switching between a standby position locked in a corresponding portion of the case and a draw-in position releasing the locking, and an urging device urging in a direction of moving both the sliders or both the latches close to each other; and
actuating members adapted to be attached to the other of the main body or the mobile body, switching the latches from the standby position to the draw-in position, or switching the latches from the draw-in position to the standby position,
wherein by switching the latch from the standby position to the draw-in position, an urging force accumulated in the urging device moves the mobile body from a first position on a main body side to a second position through the actuating member, and
at least one of either the sliders or the case is provided with a buffering portion disposed at a mutually opposed portion, and protruding toward a mating side.

3. A slide assist device according to claim 1, wherein the urging device is a coil spring integrally provided with the buffering portion which buffers a vibration and an impact applied to the slider.

4. A slide assist device according to claim 3, wherein the coil spring is fixed in the slider or the case by engaging an engaged portion formed in one portion of the coil spring with an engaging portion provided in the slider or the case;
the buffering portion is provided on an end portion side of the coil spring than the engaged portion; and
a winding pitch of the buffering portion in the coil spring is larger than at least a winding pitch of the engaged portion in the coil spring.
